(19) United States
(12) Patent Application Publication
(10) Pub. No.: US 2003/0133287 A1
(43) Pub. Date: Jul. 17, 2003

(54) Wall-mounting lamp assembly and lighting fixture therefor

(76) Inventor: Paul Chen, Taipei Hsien (TW)

Correspondence Address: Finnegan, Henderson, Farabow,, Garrett & Dunner, L.L.P., 1300 I Street, N.W., Washington, DC, 20005-3315, US

(21) Appl. No.: 10/015,589

(22) Filed: Dec. 17, 2001

(51) Int. Cl. F21S 8/00; F21S 13/02

(52) U.S. Cl. 362/147; 362/249; 362/432

(57) ABSTRACT

An improved structure of a wall-mounting lamp assembly, comprises: a tube having a circumferential surface, a first end and a second end opposite to the first end; at least one side holder secured to the circumferential surface of the tube, and at least one side illumination unit inserted into the at least one side holder; and a wall mount connecting the circumferential surface of the tube; wherein the lamp assembly further comprises: an end holder provided at one of the first end and the second end of the tube; and an end illumination unit inserted into the end holder.

### CROSS-REFERENCES TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates to a lamp assembly. Specifically, the present invention is directed to an improved structure of a wall-mounting lamp assembly, as well as an improved structure of a lighting fixture for a wall-mounting lamp assembly.

2. Description of the Related Art

FIG. 1 shows a perspective view of a conventional wall-mounting lamp assembly. As shown, a plurality of lamps are arranged along the longitudinal side of a tube. Further, a decorative head is mounted on each end of the tube. A wall mount is laterally secured to the tube for mounting the entire lamp assembly to the wall.

In addition to the ordinary lighting purpose, if the above conventional wall-mounting lamp assembly is to be used under certain circumstances, for example, used as a night light, the light emitted from the lamp assembly may be too bright for the user. Therefore, there is a need to provide a wall-mounting lamp assembly which can not only give ordinary lighting but also furnish slightly dim lighting like a night light.

### BRIEF SUMMARY OF THE INVENTION

An objective of the present invention is to provide an improved structure of a wall-mounting lamp assembly which furnishes both ordinary lighting and slightly dim lighting.

Another objective of the present invention is to provide an improved structure of a wall-mounting lamp assembly which can be used as a night light.

A further objective of the present invention is to provide an improved structure of a wall-mounting lamp assembly which is easy to assemble.

A further objective of the present invention is to provide an improved structure of a wall-mounting lamp assembly which has ornament sense and practicability.

Another further objective of the present invention is to provide an improved structure of a lighting fixture with a wall-mounting lamp assembly.

To achieve the above objectives, the improved structure of a wall-mounting lamp assembly in accordance with the present invention comprises: a tube having a circumferential surface, a first end and a second end opposite to the first end; at least one side holder secured to the circumferential surface of the tube, and at least one side illumination unit inserted into the at least one side holder; and a wall mount connecting the circumferential surface of the tube; wherein the lamp assembly further comprises: an end holder provided at one of the first end and the second end of the tube; and an end illumination unit inserted into the end holder.

Further, the present invention also discloses an improved structure of a lighting fixture for a wall-mounting lamp assembly, comprising: a tube having a circumferential surface, a first end and a second end opposite to the first end; at least one side holder secured to the circumferential surface of the tube; wherein the lighting fixture further comprises: an end holder provided at one of the first end and the second end.

The structure and objectives of the present invention can be more readily understood by persons skilled in the art from the following description of the preferred embodiments taken in conjunction with the accompanying drawings.

### BRIEF DESCRIPTION OF THE DRAWINGS

FIG. 1 is a perspective view of a conventional wall-mounting lamp assembly;

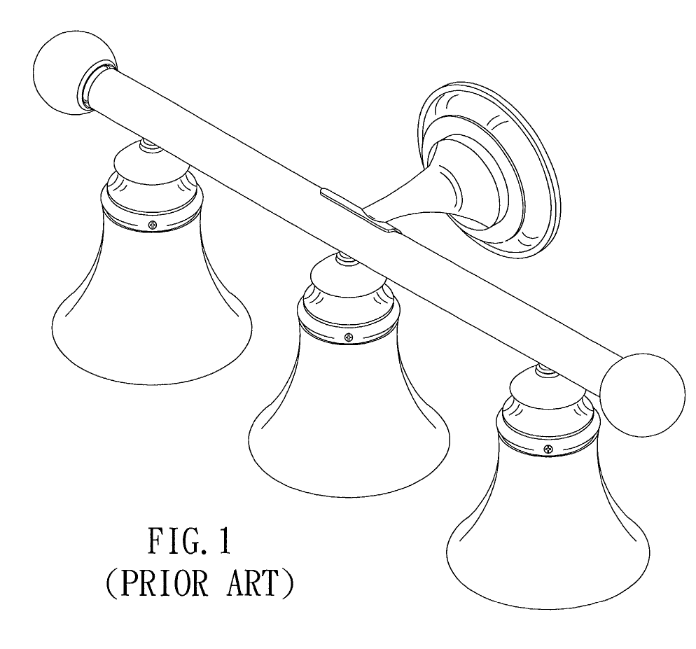

FIG. 2 is an exploded view of a wall-mounting lamp assembly in accordance with the present invention;

FIG. 3 is a partially sectional view of a wall-mounting lamp assembly in accordance with the present invention; and

FIG. 4 is a perspective view of a wall-mounting lamp assembly in accordance with the present invention.

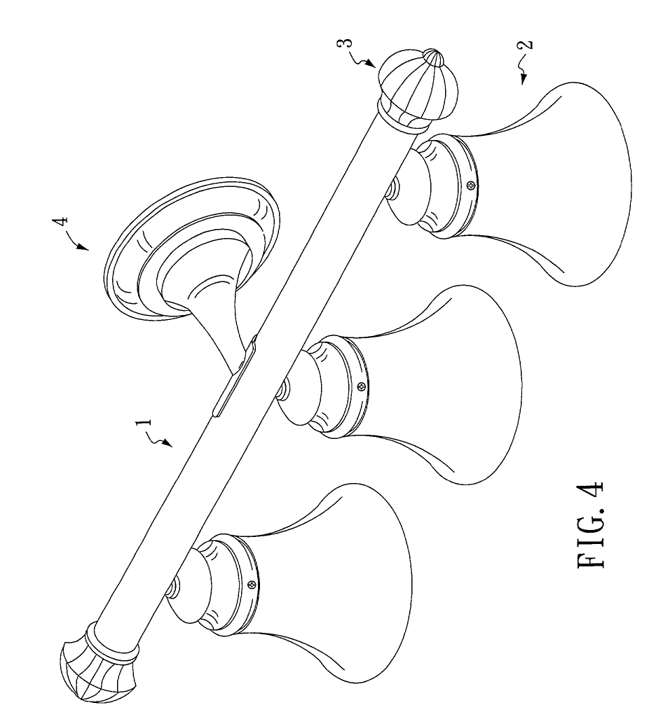

### DETAILED DESCRIPTION OF THE INVENTION

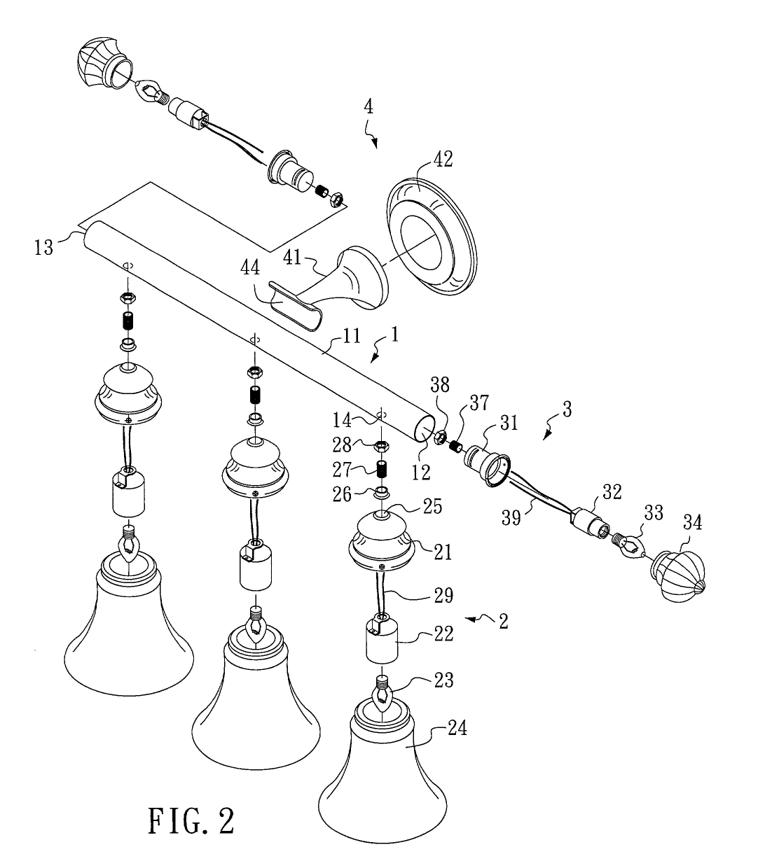

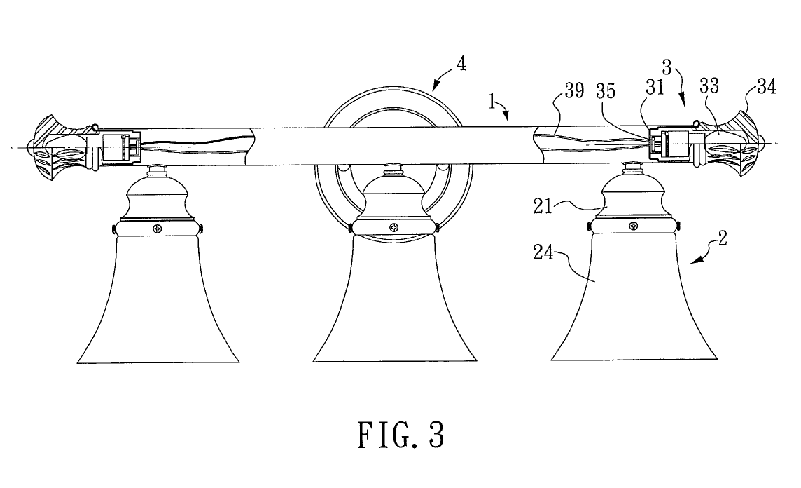

As shown in FIGS. 2 and 3, the wall-mounting lamp assembly in accordance with the present invention comprises a hollow tube 1 with a circumferential surface 11, a first end 12 and a second end 13 opposite to the first end 12. Three holes 14 are further formed downward on the circumferential surface 11 of the tube 1.

Side lamps 2 are respectively disposed on each of the holes 14 formed on the circumferential surface 11 of the tube 1. The side lamp 2 comprises a side holder 21, a side socket 22, a side illumination unit or a bulb 23 and a side shade 24. The side holder 21 is a substantially conical hollow body with an opening and a bottom opposite to the opening. The bottom forms a hole 25 thereon which aligns with the hole 14.

The side socket 22 is secured within the side holder 21 which is then secured to the circumferential surface 11 of the tube 1 by cooperating with a ball 26, a nipple 27 and a nut 28. The side socket 22 has wires 29 extending therefrom which pass through the hole 25 of the side holder 21 and the hole 14 of the tube 1.

The bulb 23 is received within the side socket 22 and is electrically connected thereto. The side shade 24 is fixed to the rim of the side holder 21 and covers the opening thereof, which thus encloses the bulb 23, the side socket 22 within the side holder 21.

End lamps 3 are respectively disposed at each of the first end 12 and the second end 13 of the tube 1. The end lamp 3 comprises an end holder 31, an end socket 32, an end illumination unit or a bulb 33 and an end shade 34. The end holder 31 is a substantially cylindrical hollow body with an opening, and a bottom opposite to the opening with a hole 35 formed thereon.

The end socket 32 is secured within the end holder 31 by cooperating with a nipple 37 and a nut 38. End holders 31 are then respectively inserted into and fixed to the first end 12 and second end 13 of the tube 1, with the edge of the opening of the end holder 31 substantially aligning with the edge of the end 12, 13. The end socket 32 has wires 39 extending therefrom which pass through the hole 35 of the end holder 31.

The bulb 33 is received within the end socket 32 and is electrically connected thereto. The end shade 34 is fixed to the rim of the end holder 31 and covers the opening thereof, which thus encloses the bulb 33, the end socket 32 within the end holder 31.

In the current preferred embodiment, the side shade 24 and the end shade 34 are both made of glass. Further, the shape of the side shade 24 and the end shade 34 can be of any desired shape and decorated with any desired pattern to obtain the functions of ornament and practicability.

A wall mount 4 is used to mount the assembly of the tube 1, the side lamps 2 and the end lamps 3 to the wall (not shown). The wall mount 4 has a substantially conical bracket 41 with a backplate 42 secured to a bottom of the bracket 41 for contacting with the wall, and a curved cover plate 44 provided on a top of the bracket 41. The curved cover plate 44 has a radius of curvature no less than the radius of the tube 1 such that the curved cover plate 44 mates with the circumferential surface 11 of the tube 1 and can be secured thereto.

Based on the above arrangement, the wall-mounting lamp assembly in accordance with the present invention is provided. Since the bulb 23 and the bulb 33 can be of different types and be independently controlled, all the side lamps 2 can be turned off and both end lamps 3 with slightly dim lighting can be turned on, if the lamp assembly is used as a night light.

Further, in accordance with the structure of the present invention, the end lamps 3 are easily assembled and secured to the ends 12, 13 of the tube 1. In addition, since the end sockets 32 are positioned within the tube 1, the provision of the end holders 31 prevents the heat generated by the bulb 33 from transmitting through the entire tube 1.

In addition, even though in the current preferred embodiment, the bulbs 23, 33 are utilized, other illumination units, such as light emitting diodes, can also be utilized.

The structure of the present invention is not limited to the above embodiments. Although the invention has been described with reference to the preferred embodiments, it will be obvious to persons skilled in the art that various changes and modifications may be made without departing from the scope of the invention as recited in the claims.

Sequencing Listing

1 Tube

11 Circumferential surface

12 First end

13 Second end

14 Hole

2 Side lamp

21 Side holder

22 Side socket

23 Bulb

24 Side shade

25 Hole

26 Ball

27 Nipple

28 Nut

29 Wire

3 End lamp

31 End holder

32 End socket

33 Bulb

34 End shade

35 Hole

37 Nipple

38 Nut

39 Wire

4 Wall Mount

41 Bracket

42 Backplate

44 Cover plate

1. An improved structure of a wall-mounting lamp assembly, comprising:
a tube having a circumferential surface, a first end and a second end opposite to the first end;
at least one side holder secured to the circumferential surface of the tube, and at least one side illumination unit inserted into the at least one side holder; and
a wall mount connecting the circumferential surface of the tube;
wherein the lamp assembly further comprises:
an end holder provided at one of the first end and the second end of the tube; and
an end illumination unit inserted into the end holder.

2. The improved structure according to claim 1, further comprising an end shade enclosing the end holder and receiving the end illumination unit therein.

3. The improved structure according to claim 2, wherein the end holder is a substantially cylindrical hollow body with an opening and a bottom which forms a hole thereon, and wherein the lamp assembly further comprising an end socket which is secured within the end holder, and has wires passing through the hole of the end holder to electrically connect the end illumination unit received in the end holder.

4. The improved structure according to claim 2, further comprising a side shade enclosing the side holder and receiving the side illumination unit therein.

5. The improved structure according to claim 4, further comprising at least one hole formed on the circumferential surface of the tube, wherein the at least one side holder is a substantially conical hollow body with an opening and a bottom which forms a hole thereon aligning with the at least one hole of the circumferential tube, and wherein the lamp assembly further comprising at least one side socket which is correspondingly secured within the at least one side holder, has wires passing through the hole of the side holder and the hole of the circumferential tube, to electrically connect the side illumination unit received in the side holder.

6. The improved structure according to claim 5, wherein each of the end illumination unit and the side illumination unit is a bulb.

7. The improved structure according to claim 5, wherein each of the end illumination unit and the side illumination unit is a light emitting diode.

8. The improved structure according to claim 6, wherein each of the side shade and the end shade is made of glass.

9. The improved structure according to claim 1, wherein the wall mount comprises a substantially conical bracket and a curved cover plate provided on a top of the bracket, the curved cover plate having a radius of curvature no less than a radius of the tube.

10. The improved structure according to claim 9, wherein the wall mount further comprises a backplate secured to a bottom of the bracket.

11. An improved structure of a lighting fixture for a wall-mounting lamp assembly, comprising:
a tube having a circumferential surface, a first end and a second end opposite to the first end;
at least one side holder secured to the circumferential surface of the tube;
wherein the lighting fixture further comprises:
an end holder provided at one of the first end and the second end.

12. The improved structure according to claim 11, further comprising an end shade enclosing the end holder and receiving an end illumination unit therein.

13. The improved structure according to claim 12, wherein the end holder is a substantially cylindrical hollow body with an opening and a bottom which forms a hole thereon, and wherein the lighting fixture further comprising an end socket which is secured within the end holder, and has wires passing through the hole of the end holder to electrically connect the end illumination unit received in the end holder.

14. The improved structure according to claim 12, wherein the end illumination unit is a bulb.

15. The improved structure according to claim 12, wherein the end illumination unit is a light emitting diode.

16. The improved structure according to claim 13, wherein the end shade is made of glass.

17. The improved structure according to claim 11, wherein the wall mount comprises a substantially conical bracket and a curved cover plate provided on a top of the bracket, the curved cover plate having a radius of curvature no less than a radius of the tube.

18. The improved structure according to claim 17, wherein the wall mount further comprises a backplate secured to a bottom of the bracket.
